(19) United States
(12) Patent Application Publication
(10) Pub. No.: US 2026/0357406 A1
(43) Pub. Date: Nov. 12, 2026

(54) ANALYSIS METHOD OF LIQUID-CONTAINING PARTICLE, MANAGING METHOD OF HOT-DIP GALVANIZING BATH, MANUFACTURING METHOD OF HOT-DIP GALVANIZED STEEL SHEET, AND ANALYZER FOR LIQUID-CONTAINING PARTICLE

(71) Applicant: NIPPON STEEL CORPORATION, Tokyo (JP)

(72) Inventors: Michihiro AIMOTO, Tokyo (JP); Norihiro TSUJI, Tokyo (JP); Tomonori AOKI, Tokyo (JP); Yuri SUGIYAMA, Tokyo (JP); Hideki NISHIMURA, Tokyo (JP)

(73) Assignee: NIPPON STEEL CORPORATION, Tokyo (JP)

(21) Appl. No.: 19/121,679

(22) PCT Filed: Nov. 30, 2023
(86) PCT No.: PCT/JP2023/042919

§ 371 Date: Apr. 16, 2025

(30) Foreign Application Priority Data
Dec. 19, 2022 (JP) 2022-202524

(51) Int. Cl. C23C 2/00; C22C 18/04; C23C 2/06

(52) U.S. Cl. CPC C23C 2/521; C22C 18/04; C23C 2/06

(57) ABSTRACT

An analysis method of a liquid containing a particle includes a step of focusing the laser beam; a step of obtaining: an emission intensity of a first element selected from elements contained in the liquid; and an emission intensity of a second element selected from elements each of which is contained in the liquid and in the particle; a step of normalizing the emission intensity of the second element with the emission intensity of the first element to obtain a normalized intensity of the second element; a step of creating a frequency distribution graph of the normalized intensity; a step of identifying: a liquid-induced peak; and a particle-induced peak in the frequency distribution graph; and a step of quantifying an abundance of the particle based on the ratio of a frequency derived from the particle-induced peak to a total frequency of the frequency distribution graph.

### TECHNICAL FIELD

The present invention relates to an analysis method of a liquid containing a particle, a managing method of a hot-dip galvanizing bath, a manufacturing method of a hot-dip galvanized steel sheet, and an analyzer for a liquid containing a particle. Priority is claimed on Japanese Patent Application No. 2022-202524, filed Dec. 19, 2022, the content of which is incorporated herein by reference.

### BACKGROUND ART

In a molten metal bath such as a hot-dip galvanizing bath in manufacturing a plated steel sheet, it is required to monitor and manage the state of molten metal for the quality control of a hot-dip galvanized steel sheet, one of the products obtained by using the same, and for the management of operating conditions.

Patent Document 1 proposes a laser emission spectroscopic analysis method of a molten metal as a molten metal analysis method during refining. In addition, Patent Document 2 discloses a method and a device in which laser-induced breakdown spectroscopy (LIBS) is applied to analysis of a molten metal material.

In addition, Patent Document 3 discloses an immersion sensor for analyzing a liquid or a melt to which LIBS is applied, wherein a measurement point is positioned at a place where the liquid or the melt is newly supplied from the opening part of an inlet to the inside of a sample chamber.

In addition, Non Patent Document 1 discloses a method in which the Al/Zn ratio of molten zinc is determined from a spectrum for each LIBS laser shot, a frequency distribution diagram is created, and the information of only molten Al is obtained, excluding the dross portion.

### CITATION LISTS

### Patent Documents

Patent Document 1: Japanese Unexamined Patent Application, First Publication No. 2006-300819
Patent Document 2: Published Japanese Translation No. 2005-530989 of the PCT International Publication
Patent Document 3: Japanese Unexamined Patent Application, First Publication No. 2008-96433

### Non Patent Document

Non Patent Document 1: Eric Baril et al, “Novel Method for On-Line Chemical Analysis of Continuous Galvanizing Baths”, Galvatech2004 Conference Proceedings, 1095-1104

### SUMMARY OF INVENTION

### Technical Problem

Molten metal often contains a particle having a size of μm level, and the particle may affect the quality of industrial products made from the molten metal. For example, alumina in molten steel or molten aluminum, and oxides and nitrides in molten titanium may become an inclusion to cause the product to have cracks and defects. In addition, in the case of a galvanized steel sheet manufactured by continuously immersing an iron plate in molten zinc, a solid material containing a Zn—Al—Fe-based alloy called dross may cause defects or poor appearance when it adheres to the steel sheet during plating. Therefore, management of particles in molten metal is extremely important for improving product quality and product yield.

However, Patent Documents 1 to 3 do not disclose analyzing particles in a liquid such as molten metal, and it is unclear whether the abundance of the particles can be analyzed. In addition, the technique disclosed in Non Patent Document 1 aims to improve the quantitative accuracy of molten Al, and has not achieved fractionation and quantification of particles and molten Al.

Conventionally, in order to quantify the particles in molten metal, first, a part of the molten metal is collected as an analysis sample with a dipper or the like. Subsequently, the molten metal is solidified using a mold or the like, but at this time, the state of the particles contained in the collected analysis sample may change due to alloying or the like. In order to avoid this change in the state of the particles, rapid cooling and solidification is performed by water cooling, or rapid cooling and solidification is performed using a mold made of a material having high heat conduction efficiency such as copper. Thereafter, the solidified analysis sample is removed from the mold and cut and polished to obtain an observed section. The observed section is observed using an optical microscope or an electron microscope, and the number (concentration) per volume, size, and elemental composition of the particle are measured. However, this method requires time and labor for cutting and polishing and observation of the sample, and there is a problem in the representativeness of the obtained quantitative value because the method is a method of observing the cross section of the analysis sample.

Therefore, the present invention has been made in view of the above problems, and an object of the present invention is to provide an analysis method of a liquid containing a particle, a managing method of a hot-dip galvanizing bath, and a manufacturing method of a hot-dip galvanized steel sheet each capable of easily quantifying the abundance of particles present in a liquid.

### Solution to Problem

The present inventors have found that the emission spectrum of the liquid and the emission spectrum of the particle in the liquid can be distinguished from each other by controlling the laser focusing condition in LIBS, and the abundance of the particle in the liquid can be quantified based on the ratio of the frequency derived from the particle-induced peak to the total frequency of the frequency distribution graph in the frequency distribution graph of the normalized intensity obtained by normalizing the emission intensity of the emission spectrum.

The gist of the present invention completed based on the above findings is as follows.
[1] An embodiment of the present invention is an analysis method of a liquid containing a particle in which a liquid containing a particle is irradiated with a laser and emission generated every time the laser is emitted is subjected to spectroscopic analysis to analyze the liquid containing a particle, the analysis method including: a laser focusing step of focusing the laser beam; an emission intensity measurement step of obtaining: an emission intensity of a first element selected from elements contained in the liquid; and an emission intensity of a second element selected from elements each of which is contained in the liquid and in the particle, and has a concentration in the liquid and a concentration in the particle, the concentrations being different from each other; a normalization step of normalizing the emission intensity of the second element with the emission intensity of the first element to obtain a normalized intensity of the second element; a frequency distribution graph creating step of creating a frequency distribution graph showing a frequency distribution of the normalized intensity; a peak identification step of identifying: a liquid-induced peak attributed to the liquid; and a particle-induced peak attributed to the particle in the frequency distribution graph; and a particle quantification step of determining the total frequency derived from the particle-induced peak and quantifying an abundance of the particle based on the ratio of a frequency derived from the particle-induced peak to the total frequency of the frequency distribution graph.
[2] The analysis method of a liquid containing a particle according to [1] may include: a calibration curve creating step of creating a calibration curve showing a relationship between: the ratio of the total frequency derived from the particle-induced peak to the total frequency of the frequency distribution graph; and an abundance of the particle by: preparing in advance liquids containing a particle and having an abundance of the particle different from each other; analyzing a sample collected from the liquid to measure an abundance of the particle in the liquid; and subjecting the liquid to the analysis method of claim 1 upon collecting the sample from the liquid to determine the ratio of the total frequency derived from the particle-induced peak to the total frequency of the frequency distribution graph, wherein, in the particle quantification step, the calibration curve may be used to quantify an abundance of the particle.
[3] In the analysis method of a liquid containing a particle according to [1], optionally, in the peak identification step, an approximate curve in the frequency distribution graph is calculated to identify: the liquid-induced peak; and the particle-induced peak, and in the particle quantification step, a frequency derived from the particle-induced peak is quantified from the calculated approximate curve.
[4] The analysis method of a liquid containing a particle according to any one of [1] to [3] may include, before the laser focusing step, an average particle size measurement step of measuring an average particle size of the particle present in the liquid.
[5] In the analysis method of a liquid containing a particle according to any one of [1] to [4], optionally, in the laser focusing step, the laser is set to have a focused spot with a diameter smaller than 10 times the average particle size of the particle.
[6] In the analysis method of a liquid containing a particle according to any one of [1] to [5], optionally, in the laser focusing step, the emission intensity measurement step is performed while changing a diameter of a focused spot of the laser, and the normalization step, the frequency distribution graph creating step, and the peak identification step are performed for each diameter of a focused spot, to determine a focusing condition of the laser.
[7] In the analysis method of a liquid containing a particle according to any one of [1] to [6], the liquid may be a molten metal.
[8] In the analysis method of a liquid containing a particle according to any one of [1] to [7], the liquid may be a molten zine alloy in which molten zinc contains at least aluminum.
[9] In the analysis method of a liquid containing a particle according to any one of [1] to [8], in the laser focusing step, the laser may be set to have a focused spot with a diameter of less than 300 μm.
[10] In the analysis method of a liquid containing a particle according to any one of [1] to [9], in the laser focusing step, the laser may be controlled to have a focused spot with a diameter of 5 μm or more and less than 100 μm.
[11] Another embodiment of the present invention is a managing method of a hot-dip galvanizing bath in which a hot-dip galvanizing bath containing a particle is irradiated with a laser and emission generated every time the laser is emitted is subjected to spectroscopic analysis to analyze the hot-dip galvanizing bath and manage the hot-dip galvanizing bath, the managing method including: a laser focusing step of focusing the laser beam; an emission intensity measurement step of obtaining: an emission intensity of a first element selected from elements contained in the hot-dip galvanizing bath; and an emission intensity of a second element selected from elements each of which is contained in the liquid and in the particle, and has a concentration in the liquid and a concentration in the particle, the concentrations being different from each other; a normalization step of normalizing the emission intensity of the second element with the emission intensity of the first element to obtain a normalized intensity of the second element; a frequency distribution graph creating step of creating a frequency distribution graph showing a frequency distribution of the normalized intensity; a peak identification step of identifying: a liquid-induced peak attributed to the liquid; and a particle-induced peak attributed to the particle in the frequency distribution graph; and a particle quantification step of determining the total frequency derived from the particle-induced peak and quantifying an abundance of the particle based on the ratio of a frequency derived from the particle-induced peak to the total frequency of the frequency distribution graph.
[12] Still another embodiment of the present invention is a manufacturing method of a hot-dip galvanized steel sheet, the manufacturing method including: a step of managing a hot-dip galvanizing bath by the managing method of a hot-dip galvanizing bath according to [11].
[13] Still another embodiment of the present invention is an analyzer for a liquid containing a particle with which a liquid containing a particle is irradiated with a laser and emission generated every time the laser is emitted is subjected to spectroscopic analysis to analyze the liquid containing a particle, the analyzer including: a laser focusing unit to concentrate the laser beam; an emission intensity measurement unit to obtain: an emission intensity of a first element selected from elements contained in the liquid; and an emission intensity of a second element selected from elements each of which is contained in the liquid and in the particle, and has a concentration in the liquid and a concentration in the particle, the concentrations being different from each other; a normalization unit to normalize the emission intensity of the second element with the emission intensity of the first element to obtain a normalized intensity of the second element; a frequency distribution graph creating unit to create a frequency distribution graph showing a frequency distribution of the normalized intensity; a peak identification unit to identify: a liquid-induced peak attributed to the liquid; and a particle-induced peak attributed to the particle in the frequency distribution graph; and a particle quantification unit to determine the total frequency derived from the particle-induced peak and to quantify an abundance of the particle based on the ratio of a frequency derived from the particle-induced peak to the total frequency of the frequency distribution graph.

### Advantageous Effects of Invention

As described above, according to the above embodiment of the present invention, it is possible to easily quantify the abundance of particles present in a liquid.

### BRIEF DESCRIPTION OF DRAWINGS

FIG. 1 A diagram illustrating an example of the configuration of a component analysis system applicable to an analysis method of a particle in a liquid according to an embodiment of the present invention.

FIG. 2 A functional block diagram showing the functional configurations of a signal processing unit.

FIG. 3 A flowchart showing the flow of the analysis method of a particle according to the embodiment.

FIG. 4 An example of an emission spectrum of an Al-containing molten zinc alloy measured by LIBS.

FIG. 5 Another example of an emission spectrum of an Al-containing molten zinc alloy measured by LIBS.

FIG. 6 An example of a frequency distribution graph in the embodiment, and an example of a frequency distribution graph of an Al-containing molten zinc alloy containing dross.

FIG. 7 An example of peaks specified in the frequency distribution graph in the embodiment, and an example of a peak attributed to dross and a peak attributed to liquid.

FIG. 8 An example of a graph showing a calibration curve of the embodiment, and a graph showing a calibration curve whose horizontal axis is the number of dross and whose vertical axis is the ratio of the frequency derived from the particle-induced peak to the total frequency of the frequency distribution graph.

FIG. 9 An example of a graph showing a calibration curve in the embodiment, and a graph showing a calibration curve whose horizontal axis is the Al concentration in the Al-containing molten zinc alloy and whose vertical axis is the normalized intensity at the peak top position of the liquid-induced peak in the frequency distribution graph.

FIG. 10 A diagram illustrating an example of the schematic configuration of a hot-dip galvanizing device to which an analysis method of a particle in a liquid according to an embodiment of the present invention can be applied.

FIG. 11 A plan view illustrating an example of the schematic configuration of a hot-dip galvanizing device to which the analysis method of a particle in a liquid according to the embodiment can be applied.

FIG. 12 A frequency distribution graph of Level 1 in Example.

FIG. 13 A frequency distribution graph of Level 2 in Example.

FIG. 14 A frequency distribution graph of Level 3 in Example.

FIG. 15 A frequency distribution graph of Level 4 in Example.

FIG. 16 A frequency distribution graph in Comparative Example.

### DESCRIPTION OF EMBODIMENTS

Hereinafter, preferred embodiments of the present invention will be described in detail with reference to the accompanying drawings.

### <Particle Analysis System>

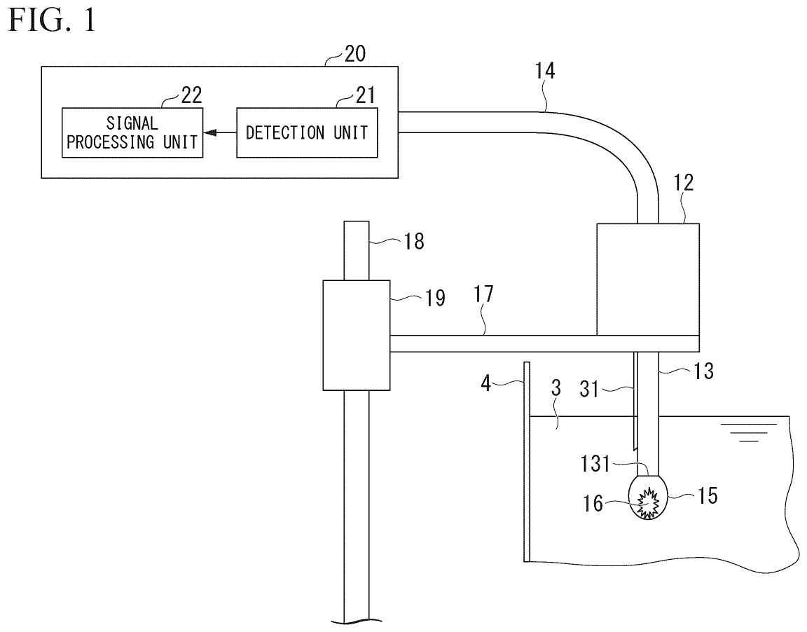

First, prior to the description of the analysis method of a liquid containing a particle according to an embodiment of the present invention, an example of a component analysis system for a particle capable of performing the analysis method of a liquid containing a particle according to the embodiment will be described. FIG. 1 is a diagram illustrating an example of the configuration of a component analysis system 11 according to the embodiment. As illustrated in FIG. 1, the component analysis system 11 according to the embodiment has a configuration for performing LIBS, and includes, for example, a laser device 12, a cylindrical probe 13, a transmission cable 14, a support member 17, a fixing member 18, a drive unit 19, and a processing device 20. The description of the particle analyzer will be described where the liquid is molten metal as an embodiment thereof.

The laser device 12 is a device including a laser oscillator (not illustrated) that emits a pulsed laser beam (hereinafter, also simply referred to as “laser”) and an optical system (not illustrated) that guides the pulsed laser beam to the cylindrical probe 13 whose tip is immersed in a molten metal 3, and guides plasma-induced light received via the cylindrical probe 13 to the transmission cable 14. The laser oscillator has a function of generating plasma at the gas-liquid interface between a gas supplied to the molten metal 3 through the cylindrical probe 13 described later and the molten metal 3 by the laser oscillated therefrom. The laser oscillator preferably has a function of emitting a pulsed laser light that evaporates the molten metal 3 and the components contained in the particles contained in the molten metal 3 without selectivity. For example, the laser oscillator emits a pulse through a Q-switch system or the like, and emits a laser having an output of 10 to 200 mJ/pulse and a wavelength of about a fundamental wave to a triple wave. For example, the laser oscillator may be a Nd: YAG laser, a diode laser, or the like, which are widely used as a high-output pulsed laser. The frequency of the pulse may be, for example, about 1 to 50 Hz. The pulse width of the laser is preferably several nsecs to several psecs.

In addition, the laser device 12 may have an adjusting mechanism to adjust the spot diameter of the laser or the like.

The optical system includes an optical system that guides the laser emitted from the laser oscillator to the cylindrical probe 13, and an optical system that guides plasma-induced light received via the cylindrical probe 13 to the transmission cable 14. These optical systems are each constituted by optical members such as a lens, a mirror, a dichroic mirror, or a collimator. The optical system may have an adjusting mechanism to adjust the spot diameter of the laser or the like.

The cylindrical probe 13 is a cylindrical member constituting the optical path between the molten metal 3 and the laser device 12, and is disposed such that one end thereof is connected to the laser device 12 and the other end thereof, which is an opening end 131, is immersed in the molten metal 3. The pulsed laser beam emitted from the laser device 12 is guided in the cylindrical probe 13, and focused by a dichroic mirror or a lens to focus on the molten metal 3 containing particles to be analyzed on the opening end 131 side. In addition, in the cylindrical probe 13, an inert gas is supplied from an arbitrary position toward the opening end 131. As illustrated in FIG. 1, the inert gas is discharged from the opening end 131 into the molten metal 3 and is foamed to generate bubbles 15. The molten metal 3 is irradiated with the laser guided via the cylindrical probe 13, whereby plasma 16 is generated at the gas-liquid interface between the generated bubbles 15 and the molten metal 3. The elements constituting the particle and the molten metal are decomposed at the atomic level in the plasma 16 and then excited, and relaxed to generate light emission. The inert gas is preferably an inert gas generally used in plasma emission spectrometry, such as Ar or He. The opening end 131 of the cylindrical probe 13 may be perpendicular or oblique to the longitudinal direction.

The transmission cable 14 is a cable to transmit the light that has caused plasma emission in the molten metal 3 and has been guided to the laser device 12 via the cylindrical probe 13 to the processing device 20. The transmission cable 14 is implemented by a general light guide cable such as an optical fiber cable.

The support member 17 supports the laser device 12 and the cylindrical probe 13. The support member 17 can be, for example, a plate-shaped table. In addition, the support member 17 is driven to have an angle with respect to the horizontal plane by a drive means such as a built-in motor included in the drive unit 19 described later. This makes it possible to change the angle of the cylindrical probe 13 with respect to the vertical direction. Note that the support member is not limited to the illustrated embodiment, and may be, for example, a member capable of holding the laser device 12 and the cylindrical probe 13 or a member from which the laser device 12 and the cylindrical probe 13 can be suspended.

The fixing member 18 is a rod-shaped member disposed outside a plating tank 4 and having a positional relationship fixed with respect to the plating tank 4. The drive unit 19 is attached to the fixing member 18.

The drive unit 19 fixes the support member 17 and is movable along the fixing member 18. The drive unit 19 moves to an arbitrary position along the fixing member 18 by a drive means such as a built-in motor. This makes it possible to change the immersion depth of the opening end 131 of the cylindrical probe 13 in a plating bath 3. That is, the support member 17 supporting the laser device 12 and the cylindrical probe 13 is movable with respect to the fixing member 18 using the drive unit 19, whereby the position of the opening end 131 of the cylindrical probe 13 can be controlled.

The processing device 20 has a function of dispersing and detecting the light transmitted via the transmission cable 14 and processing the obtained signal. The processing device 20 includes a detection unit 21 and a signal processing unit 22.

The detection unit 21 disperses the light transmitted via the transmission cable 14 and records the dispersed light as an emission spectrum. The emission spectrum is collected and recorded for each shot (pulse) of the laser. For example, the detection unit 21 can be implemented by a spectrometer and a photoelectric converter. The spectrometer has wavelength resolution and sensitivity sufficient for the emission intensity at the wavelength of the elements to be measured in the particle and the molten metal, and is preferably, for example, an Echelle type or a Czerney-Turner type. In addition, the photoelectric converter can perform signal processing of all pulses of the laser at an operation speed of a predetermined frequency, and has sensitivity sufficient for the wavelength of the constituent elements to be measured in the particle and the molten metal. The photoelectric converter may be, for example, an optical sensor such as a charge coupled device (CCD) or a complementary metal oxide semiconductor (CMOS) including an image intensifier, or a photomultiplier tube (PMT). The detection unit 21 according to the embodiment measures a signal in a wavelength band including the wavelengths corresponding to the elements contained in the molten metal 3 and the elements contained in the particle, and outputs the signal as measurement data. The measurement data regarding the signal corresponding to each element detected by the detection unit 21 is output to the signal processing unit 22.

The signal processing unit 22 has a function of performing processing on the acquired measurement data (signal). To the measured spectrum, the signal processing unit 22 performs calculation of the peak intensity at the wavelength of the element to be measured in the particle and in the molten metal, normalization, calculation of frequency of appearance, creation of a frequency distribution graph, and peak separation.

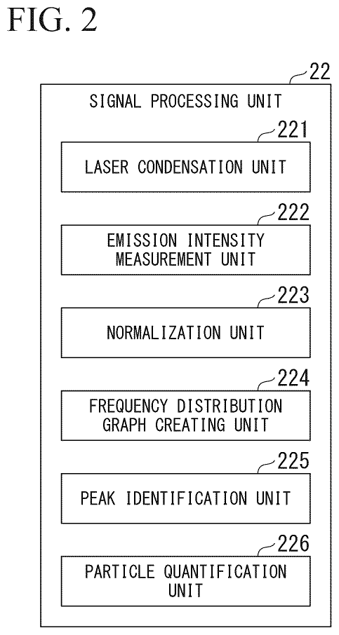

FIG. 2 exemplifies a functional block diagram showing the functional configurations of the signal processing unit 22. As shown in FIG. 2, the signal processing unit 22 includes: a laser focusing unit 221 to concentrate the laser beam; an emission intensity measurement unit 222 to obtain: an emission intensity of a first element selected from elements contained in the molten metal 3; and an emission intensity of a second element selected from elements each of which is contained in the molten metal 3 and in the particle, and has a concentration in the molten metal 3 and a concentration in the particle, the concentrations being different from each other; a normalization unit 223 to normalize the emission intensity of the second element with the emission intensity of the first element to obtain a normalized intensity of the second element; a frequency distribution graph creating unit 224 to create a frequency distribution graph showing a frequency distribution of the normalized intensity; a peak identification unit 225 to identify: a liquid-induced peak attributed to the molten metal 3; and a particle-induced peak attributed to the particle in the frequency distribution graph; and a particle quantification unit 226 to determine the total frequency derived from the particle-induced peak and quantify an abundance of the particle based on the ratio of a frequency derived from the particle-induced peak to the total frequency of the frequency distribution graph.

In the laser focusing unit 221, for example, the optical system is controlled so that the laser has a focused spot with a predetermined diameter (focused size). Specifically, the focuser (for example, an optical device also referred to as an optical system or a lens system such as a collimator and a focal lens) is controlled to obtain a target focused size. Note that it is not necessary to control the focusing conditions as the signal processing when an appropriate focusing conditions are determined by a preliminary test or the like and the optical system is set to the focusing conditions.

The signal processing unit 22 is implemented by hardware including, for example, an arithmetic device or a processor such as a CPU, a main storage device such as a read only memory (ROM) or a random access memory (RAM), and an auxiliary storage device such as a hard disk or a flash memory. The signal processing unit 22 may be constituted by one piece of hardware or a plurality of pieces of hardware. Note that the signal processing unit 22 may be implemented by an embedded system.

### <Analysis Method of Liquid>

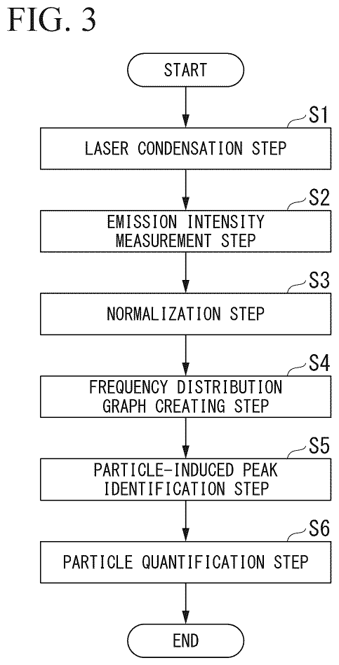

Next, the analysis method of a liquid containing a particle according to an embodiment of the present invention will be described with reference to FIG. 3. FIG. 3 is a flowchart showing the flow of the analysis method of a liquid containing a particle according to the embodiment. Hereinafter, the analysis method of a liquid containing a particle using the above-described component analysis system 11 will be described. However, the present invention is not limited to such examples.

The analysis method of a liquid containing a particle according to the embodiment is an analysis method of a liquid containing a particle in which a liquid containing a particle is irradiated with a laser and emission generated every time the laser is emitted is subjected to spectroscopic analysis to analyze the liquid containing a particle. The analysis method of a liquid containing a particle according to the embodiment includes: a laser focusing step of focusing the laser beam (step S1); an emission intensity measurement step of obtaining: an emission intensity of a first element selected from elements contained in the liquid; and an emission intensity of a second element selected from elements each of which is contained in the liquid and in the particle, and has a concentration in the liquid and a concentration in the particle, the concentrations being different from each other (step S2); a normalization step of normalizing the emission intensity of the second element with the emission intensity of the first element to obtain a normalized intensity of the second element (step S3); a frequency distribution graph creating step of creating a frequency distribution graph showing a frequency distribution of the normalized intensity (step S4); a particle-induced peak identification step of identifying: a liquid-induced peak attributed to the liquid; and a particle-induced peak attributed to the particle in the frequency distribution graph (step S5); and a particle quantification step of determining the total frequency derived from the particle-induced peak and quantifying an abundance of the particle based on the ratio of a frequency derived from the particle-induced peak to the total frequency of the frequency distribution graph (step S6). The liquid to be measured is not particularly limited, and may be, for example, water or molten metal containing a particle. The molten metal may be a molten zinc alloy in which molten zinc contains at least aluminum (Al-containing molten zinc alloy). The first element is different from the second element.

### [Laser Focusing Step (Step S1)]

In the laser focusing step, the laser is focused so that the diameter of the focused spot (focused size) is appropriate for specifying the liquid-induced peak and the particle-induced peak in the peak identification step as described later, and emitted to the liquid containing a particle. In this step, for example, the focused size is preferably adjusted to be smaller than 10 times the average particle size of the particle. This is because the signal attributed to the particle is not covered with the signal from the liquid as the matrix. In this case, in the peak identification step described later, the liquid-induced peak and the particle-induced peak are easily identified, that is, the liquid-induced peak and the particle-induced peak are easily separated.

For example, when the particle present in the laser focused spot has a size, and the size, that is, the diameter of the particle, is one-tenth of the diameter of the laser focused spot, the particle occupies one hundredth the area of the laser focused spot. That is, for the emission spectrum intensity from the particle, it is assumed that the percentage of the emission from the particle is 1% of the emission spectrum from the non-particle portion, that is, the molten metal.

On the other hand, in an alloying hot-dip galvanizing bath, the particle to be measured is dross. It has been reported that the composition thereof has an Al concentration of 44 to 45 mass %, an Fe concentration of 37 to 38 mass %, and a Zn concentration of 18 to 19 mass % (ISIJ International, Vol. 61 (2021), No. 3, pp. 937-944). The composition of an alloying hot-dip galvanizing bath generally has about 0.12 to 0.14 mass % of Al and about 0.03 to 0.05 mass % of Fe. Therefore, the particle contains 314 to 375 times higher concentration of Al and 740 to 1266 times higher concentration of Fe than the molten metal. Therefore, when one particle having a size of 1/10 of the laser focused spot size (average particle size) is included, it can be calculated that the emission intensity of Al is about 3 times and the emission intensity of Fe is about 7 to 12 times.

On the other hand, in the case of a laser having a power of several tens of mJ/pulse and a pulse width of several nanoseconds, which is generally used in LIBS, the stability of the emission intensity is generally from several percent to ten some percent. It is assumed that the stability is 20% or more for molten metal in consideration of subtle variations in the position of the analysis surface and the like.

Here, the lower limit of quantitation in the analysis means the minimum amount or the minimum concentration at which the analyte can be quantified by a certain analysis method, and is generally 10 times the background variation (standard deviation). Assuming that the stability of the emission intensity is 20% in the absence of particles, 10 times thereof is 200%, that is, a significant signal for quantitative analysis cannot be obtained when the signal intensity is increased to about two times the original emission intensity. Here, when the size of the particle is greater than 1/10 the size of the laser focused spot, it can be calculated that the obtained signal intensity is about 3 times (300%) or more for Al, and is about 7 to 12 times (700 to 1200%) or more for Fe. Therefore, it can be said that quantitative analysis can be performed since a signal significantly exceeding 200%, which is 10 times the variation in emission intensity, is obtained. When the size of the particle is smaller than 1/10 the size of the laser focused spot, the percentage of the emission signal from the particle in the obtained emission signal is reduced by the square, which is not significant for the stability of the emission intensity, and a signal intensity sufficient to separately analyze the particle cannot be obtained. Therefore, although the emission intensity of the laser and the variation thereof are greatly affected by the wavelength and output of the laser beam, the pulse width, the focusing conditions, the state of the analysis target, and the like, the size of the laser focused spot is preferably smaller than 10 times the average diameter of the particle (average particle size) for quantitative analysis.

For example, when the average particle size of the particle is 10 to 20 μm, the diameter of the laser focused spot is preferably about 50 μm. On the other hand, the laser focusing includes a technique of cutting with an aperture. However, in the technique, it may be difficult to perform focusing while maintaining the photon density. Therefore, the diameter of the focused spot is preferably 5 μm or more from the viewpoint of performing laser-induced emission analysis while maintaining the analysis sensitivity. In the conventional LIBS, the laser focused size is about 300 μm to 1 mm, and is significantly larger than the diameter of the particle contained in the liquid. Therefore, in the conventional method, it is difficult to separately analyze the liquid and the particle with high accuracy. In the embodiment, from the viewpoint of performing analysis with high accuracy, the laser focused size is preferably less than 300 μm, and more preferably less than 200 μm, less than 100 μm, less than 80 μm, or less than 60 μm. When the diameter of the focused spot of the laser is reduced, the frequency at which particles are included in the spot is reduced, but the analysis accuracy can be enhanced by increasing the oscillation frequency of the laser or appropriately setting the measurement time. Preferably, the diameter of the focused spot of the laser emitted to a liquid containing a particle is, in advance, checked for how much the size is focused, for example, using a thermosensitive paper, a laser beam profiler, or the like, depending on the used laser or focuser (for example, an optical device also referred to as an optical system or a lens system such as a collimator and a focal lens), and depending on the position in the analysis target (the surface position of a liquid containing a particle as the analysis target), and an appropriate optical system is selected or adjusted depending on the average particle size of the particle to be measured. Here, examples of selection or adjustment of the optical system, the lens system, and the like include selection or adjustment of the focal length of the aperture or the lens, adjustment of the position of the lens in the optical axis direction, and the like. When the laser focused spot size is very larger than the particle size (average particle size), the probability that the particle exists immediately below the laser also increases, but the probability that the particle does not exist immediately below the laser greatly decreases. For this reason, in the frequency distribution graph creating step described later, a frequency distribution graph having two peaks cannot be obtained. Therefore, it is necessary to reduce the focused spot size to increase the probability that no particle exists immediately below the laser. On the other hand, when the focused spot size is very small, the probability that the particle exists immediately below the laser is greatly reduced. Therefore, in the frequency distribution graph creating step described later, a frequency distribution graph having two peaks cannot be necessarily obtained. Therefore, the laser focused spot size has an appropriate range.

The average particle size of the particle in the liquid can be determined by measuring the particle size distribution by laser scattering measurement or the like, for example, when the liquid containing a particle is an aqueous solution or the like. In the case of molten metal, the molten metal is sampled, solidified, then cut, the polished cut surface is measured with a microscope, and the average particle size can be determined using image processing.

In the peak identification step, the appropriate spot size (focused size) at which the liquid-induced peak and the particle-induced peak can be specified depends not only on the particle size (average particle size) but also on the chemical composition difference between the liquid and the particle (difference in the amount of the second element described later), variation in the particle size, and the like. For example, when the difference in chemical composition is small, the spot size needs to be smaller. For this reason, even when the spot size is obtained by automatically multiplying the particle size by a certain coefficient, the liquid-induced peak and the particle-induced peak cannot be necessarily identified (separated). It is essential to focus to a spot size capable of identifying the liquid-induced peak and the particle-induced peak in the peak identification step. When the liquid-induced peak and the particle-induced peak can be identified (separated) in the peak identification step, it is not necessary to adjust the ratio between the average particle size and the focused spot size. For example, if the liquid-induced peak and the particle-induced peak can be identified (separated) by chance in the peak identification step when focusing is performed in an optical system and a lens system by a preliminary test or the like, the focusing conditions in the optical system and the lens system obtained by chance may be adopted (without the need to adjust the spot size itself).

In the laser focusing step, preferably, the laser is focused in advance under a plurality of focusing conditions, the emission intensity measurement step, the normalization step, the frequency distribution graph creating step, and the particle-induced peak identification step as described above are performed under each focusing condition, and the optimum focusing condition is determined in which the liquid-induced peak and the particle-induced peak can be identified (separated). As a result, it is possible to optimize the focusing condition, that is, to determine a more appropriate focused size, and it is possible to distinguish the liquid and the particle with higher accuracy. For example, it is preferable to control the diameter of the laser focused spot to 5 μm or more and less than 100 μm.

### [Emission Intensity Measurement Step (Step S2)]

In the emission intensity measurement step, the emission intensity of a first element selected from elements contained in the liquid; and an emission intensity of a second element selected from elements each of which is contained in the liquid and in the particle, and has a concentration in the liquid and a concentration in the particle, the concentrations being different from each other, are obtained. This step is performed by LIBS. Specifically, the emission spectrum is collected for each pulse of the laser. In the collected spectrum, an emission intensity of a first element selected from elements contained in the liquid; and an emission intensity of a second element selected from elements each of which is contained in the liquid and in the particle, and has a concentration in the liquid and a concentration in the particle, the concentrations being different from each other, are calculated. The emission spectrum includes continuous light generated from plasma in addition to the emission from each element. Therefore, the peak intensity is calculated through the peak height method or the peak area method after the baseline (the background caused by the continuous light from the plasma) is subtracted. Note that supply of the inert gas, irradiation with a laser, and detection and spectroscopic analysis of plasma emission can be performed by conventionally known methods.

The first element may be an element contained in the liquid, but is preferably an element having the largest content among elements constituting the liquid from the viewpoint of small concentration change and improvement in measurement accuracy. As described above, the second element is an element that is contained in the liquid and in the particle and has a concentration in the liquid and a concentration in the particle, the concentrations being different from each other.

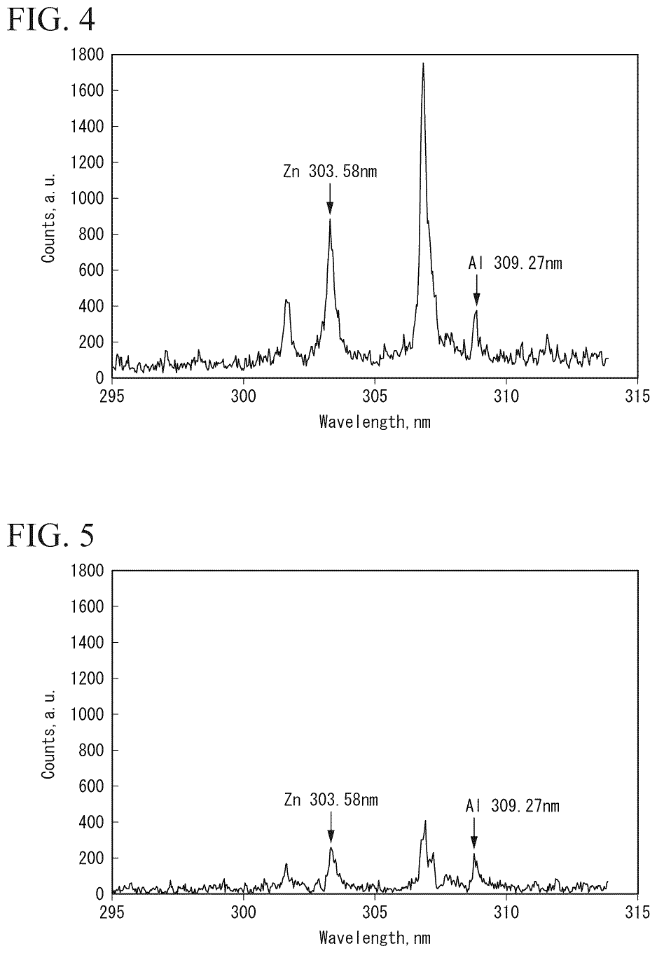

For example, when the liquid is an Al-containing molten zinc alloy, the Al-containing molten zinc alloy contains a large amount of alloy (Fe₂Al₅Znₓ) particles called dross having a higher Al content ratio than the Al-containing molten zinc alloy. In the Al-containing molten zinc alloy containing dross, for example, the first element is Zn and the second element is Al, and their emission intensity is calculated. FIG. 4 is an example of an emission spectrum presumably when the laser is emitted at the molten metal portion in the Al-containing molten zinc alloy to be measured by LIBS. In FIG. 5, the emission intensity of Zn is relatively smaller and the emission intensity of Al is relatively larger than in the emission spectrum in FIG. 4. For this reason, FIG. 5 is an example of an emission spectrum when the Al-containing molten zinc alloy containing a large amount of dross is irradiated with the laser. The Al-containing molten zinc alloy is a liquid, and is easily vaporized by thermal energy applied by the laser, and many atoms excite and emit light in a plasma generated by the laser. Therefore, as shown in FIG. 4, when the molten metal is irradiated, the emission intensity of Zn increases. On the other hand, when the dross is irradiated with the laser, the dross is solid and has a high boiling point, and thus the number of atoms vaporized and introduced into the plasma is smaller than in the molten metal. As a result, as shown in FIG. 5, when the dross is irradiated, the emission intensity of Zn decreases. In addition, regarding the ratio of the emission intensity of Al to the emission intensity of Zn, the emission intensity of Al is relatively larger in the dross than in the molten metal. This is because the dross, in which Al, Fe, and Zn are alloyed, has a relatively larger proportion of Al than the molten metal, in which Al is dissolved in a relatively dilute manner.

Note that the emission spectrum includes emission accompanying relaxation from an electronically excited state (atomic line), and emission accompanying relaxation from an ionized state (ion line). As a method for selecting the first element and the second element, preferably, the same type is selected from ion line and atomic line; more preferably, elements having a close energy level leading to excitation are selected. However, the method is not limited thereto, and elements having a close emission intensity or emission wavelength may be selected.

### (Normalization Step (Step S3))

In the normalization step, the emission intensity of the second element is normalized with the emission intensity of the first element to obtain the normalized intensity of the second element. That is, in the normalization step, the ratio of the emission intensity of the second element to the emission intensity of the first element (emission intensity of second element/emission intensity of first element) is calculated.

### (Frequency Distribution Graph Creating Step (Step S4))

In the frequency distribution graph creating step, a frequency distribution graph (histogram) showing a frequency distribution of appearance of the normalized intensity of the second element normalized in the normalization step is created. The emission wavelength and emission intensity of the element reflect the element composition at the laser irradiation portion. In this step, in order to classify the emission attributed only to the liquid and the emission attributed to the particle in the next step, the particle-induced peak identification step, for the element contained in the particle (second element) from the above-described normalized intensity, a frequency distribution graph whose horizontal axis represents the normalized intensity and whose vertical axis represents the frequency of appearance of each normalized intensity for each pulse is created. When the particle is quantified, it is preferable to obtain the sum of the frequency derived from the particle-induced peak from the approximate curve, and thus, the width of each bin in the histogram) are all equal to each other. The bin on the horizontal axis of the frequency distribution graph and the number of pulses n per analysis are preferably determined by the size and number of particles in the liquid to be measured and the degree of flow of the liquid so that the frequency distribution graph draws a smooth curve. For example, when the liquid contains particles at a concentration of several 10 ppm level, it is preferable to obtain data at several 1000 to 10000 pulses. In order to obtain higher analysis accuracy, it is preferable to increase the integration time to collect a large amount of data or to increase the number of bins at the time of creating a histogram.

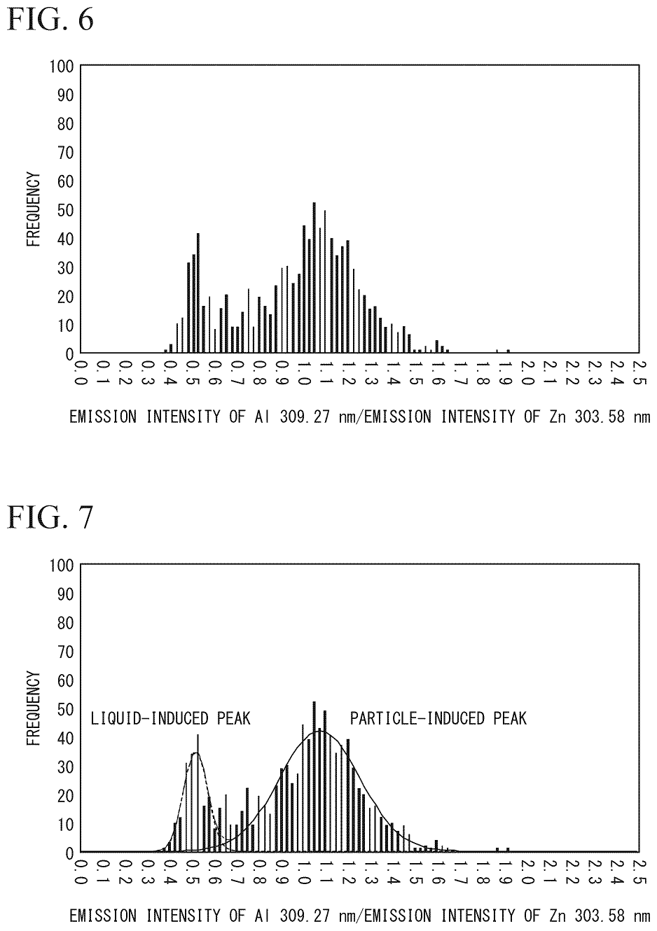

FIG. 6 is an example of a frequency distribution graph created by the strength of Al/Zn on the horizontal axis and the appearance frequency thereof on the vertical axis in the Al-containing molten zinc alloy containing dross. In the Al-containing molten zinc alloy containing dross, as shown in FIG. 6, a bimodal (having two peaks) frequency distribution graph is obtained.

### (Peak Identification Step (Step S5))

In the peak identification step, a liquid-induced peak attributed to the liquid; and a particle-induced peak attributed to the particle in the frequency distribution graph are identified. When there is an overlap of distributions in the frequency distribution graph, peaks are separated using a deconvolution method for peaks. Specifically, it is preferable to perform fitting by Gauss-Newton method or the like, more specifically, fitting with an approximate curve by a known method such as Levenberg-Marquardt method or Powell's Dog Leg method, and to separate each peak. That is, when there is an overlap of distributions in the frequency distribution graph, it is preferable to separate the liquid-induced peak and the particle-induced peak by calculating an approximate curve in the frequency distribution graph.

When the liquid-induced peak and the particle-induced peak do not overlap each other in the frequency distribution graph, there is no need to calculate an approximate curve. In such a case, the frequency derived from the liquid-induced peak and the frequency derived from the particle-induced peak can be easily obtained without separating the liquid-induced peak and the particle-induced peak. Therefore, the particle quantification step described later may be performed.

In the embodiment, specifying the liquid-induced peak and the particle-induced peak means separating the liquid-induced peak and the particle-induced peak by fitting with an approximate curve or the like as necessary. However, when the liquid-induced peak and the particle-induced peak do not overlap each other, specifying the liquid-induced peak and the particle-induced peak means confirming that the liquid-induced peak and the particle-induced peak do not overlap each other.

When the laser is emitted only to the liquid, the emission signal includes information on the elements constituting the liquid. When the laser is emitted to a portion where the particle is contained in the liquid, the emission signal includes information on the elements constituting not only the liquid but also the particle. The particle in the liquid is a solid having a composition different from that of the liquid. Therefore, when the laser is emitted to a portion where the particle is contained in the liquid, the emission signal includes information on elements different from that of the liquid alone, or is different in emission intensity. Therefore, the frequency distribution graph created in the frequency distribution graph creating step includes information on the particle in the liquid. For example, when the target is a common element contained in the particle and in the liquid, and the element is contained in a larger amount in the composition of the particle than in the composition of the liquid, the frequency distribution graph has two peak intensity distributions. Among them, when the amount of the second element in the particle is larger than the amount of the second element in the liquid, the peak on the low intensity side reflects the liquid, and the peak on the high intensity side reflects the particle. Although each of the peaks is broad, the peak on the low intensity side attributed to the liquid draws a distribution close to a normal distribution based on the variation in analysis, whereas the peak on the high intensity side attributed to the particle is often a broader peak including the variation based on the particle size in addition to the variation in analysis.

FIG. 7 is an example of peaks specified in the frequency distribution graph in the embodiment, and an example of the peak of the dross and the peak of the Al-containing molten zinc alloy. When the liquid is an Al-containing molten zinc alloy, as described above, the ratio of the Al emission intensity to the Zn emission intensity Al/Zn in the dross is relatively larger than Al/Zn in the molten metal. Therefore, it can be determined that the peak located on the low Al/Zn side is a peak attributed to the molten zinc and the peak located on the high Al/Zn side is a peak attributed to the dross.

### (Particle Quantification Step (Step S6))

In the particle quantification step, the total frequency derived from the particle-induced peak is determined and an abundance of the particle is quantified based on the ratio of a frequency derived from the particle-induced peak to the total frequency of the frequency distribution graph. When the approximate curve of the frequency distribution graph is calculated in the peak identification step, it is preferable to quantify the frequency derived from the particle-induced peak from the calculated approximate curve. At this time, the area of the approximate curve derived from the particle-induced peak may be regarded as the frequency derived from the particle-induced peak, and the sum of the area of the approximate curve derived from the liquid-induced peak and the area of the approximate curve derived from the particle-induced peak may be regarded as the total frequency of the frequency distribution graph. That is, the “the area of the approximate curve derived from the particle-induced peak”/(“the area of the approximate curve derived from the liquid-induced peak”+ “the area of the approximate curve derived from the particle-induced peak”) may be regarded as the ratio of the frequency derived from the particle-induced peak to the total frequency of the frequency distribution graph.

If necessary, the abundance of the particle may be quantified from a parameter other than the ratio of the frequency derived from the particle-induced peak to the total frequency of the frequency distribution graph, when the parameter is uniquely determined from the ratio of the frequency derived from the particle-induced peak to the total frequency of the frequency distribution graph. For example, instead of the ratio of the frequency derived from the particle-induced peak to the total frequency of the frequency distribution graph, the abundance of the particle may be quantified from the ratio between the frequency derived from the liquid-induced peak and the frequency derived from the particle-induced peak. When the total frequency is limited to a fixed frequency by fixing the frequency of the pulse of the laser, the pulse width of the laser, and the measurement time of LIBS, including the calibration curve creating step, the abundance of the particle may be quantified from the frequency of the particle-induced peak alone (without calculating the total frequency). In the embodiment, these modifications are not excluded.

### (Calibration Curve Creating Step (Step S0))

In order to determine the number density of the abundance of the particle, for example, the calibration curve creating step as follows is preferably included before the particle quantification step. In the calibration curve creating step, preferably, a calibration curve showing a relationship between: the ratio of a frequency derived from the particle-induced peak to the total frequency of the frequency distribution graph; and an abundance of the particle is created in advance by: preparing in advance liquids containing a particle and having an abundance of the particle different from each other; analyzing a sample collected from the liquid to measure an abundance of the particle (for example, number density) in the liquid; and subjecting the liquid to the analysis method described above upon collecting the sample from the liquid. As the standard sample, a plurality of standard samples different in at least one of the number of particles, the average particle size, and the particle size distribution is used. When the liquid is molten metal, the quantification of particle in the standard sample is performed, for example, by observing the cut and polished surface described above. The components of the molten metal are analyzed with a high-frequency inductively coupled plasma analyzer, an atomic absorption spectrometer, or the like, after a part of the analysis sample described above is cut with a drill or the like, and the cut powder is dissolved with an acid or the like. The components of the molten metal may be calculated using a phase diagram or the like from the composition and temperature of the molten metal. Since the analysis value is the sum of the molten metal and the particle, the components of the molten metal can be calculated by subtracting the quantitative result of the particle obtained by the observation of the cut and polished surface or the calculation from the phase diagram.

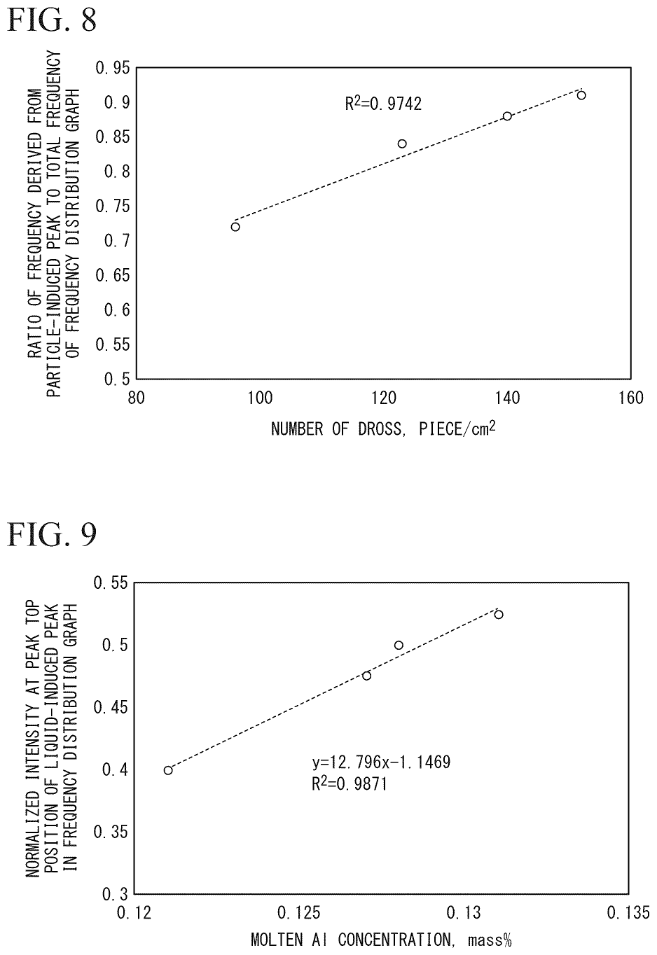

FIG. 8 is an example of a graph showing a calibration curve in the embodiment, and a graph showing a calibration curve whose horizontal axis is the number of dross and whose vertical axis is the ratio of the frequency derived from the particle-induced peak to the total frequency of the frequency distribution graph. Here, the ratio of the frequency derived from the particle-induced peak to the total frequency of the frequency distribution graph is calculated based on the curve obtained by curve fitting the frequency distribution graph and the area of the region surrounded by the X axis of the frequency distribution graph. That is, the “the area of the approximate curve derived from the particle-induced peak”/(“the area of the approximate curve derived from the liquid-induced peak”+“the area of the approximate curve derived from the particle-induced peak”) is regarded as the ratio of the frequency derived from the particle-induced peak to the total frequency of the frequency distribution graph. Also in the calibration curve creating step, when the liquid-induced peak and the particle-induced peak do not overlap each other in the frequency distribution graph, there is no need to calculate an approximate curve. When these peaks overlap, it is preferable to calculate an approximate curve. In order to obtain a highly accurate calibration curve, it is preferable to create a calibration curve every time different laser transmitters, optical systems for guiding or focusing light (for example, a focused size or the like), optical systems for guiding received plasma-induced light to the transmission cable 14, and the like are used.

Next, when a calibration curve is created, the particle quantification step includes quantifying the abundance of the particle in the liquid containing a particle as the sample to be measured based on the calibration curve based on the measurement result of the ratio of the frequency derived from the particle-induced peak to the total frequency of the frequency distribution graph. For example, the number of dross in the Al-containing molten zinc alloy can be quantified by applying the measured ratio of a frequency derived from the particle-induced peak to the total frequency of the frequency distribution graph to the calibration curve as shown in FIG. 8.

The calibration curve creating step may be omitted. For example, when this analysis method is used to reduce defects and appearance defects of the steel sheet after plating, optionally, the calibration curve creating step is omitted and the “ratio of the frequency derived from the particle-induced peak to the total frequency of the frequency distribution graph” itself is to be controlled so that the plating bath is managed or controlled without calculating the abundance of the particle (dross) by using the calibration curve created in the calibration curve creating step. More specifically, if the relationship between the defect rate (or appearance defect rate) of the steel sheet after plating and the “ratio of the frequency derived from the particle-induced peak to the total frequency of the frequency distribution graph” can be clarified, optionally, the appropriate range of the “ratio of the frequency derived from the particle-induced peak to the total frequency of the frequency distribution graph” is determined in advance according to the clarified content, and the plating bath operating conditions (plating bath temperature, chemical composition of the plating bath, and the like) are managed or controlled so that the “ratio of the frequency derived from the particle-induced peak to the total frequency of the frequency distribution graph” falls within the predetermined appropriate range.

Since the area ratio of the particle (dross) in the laser irradiation area in each laser pulse has a certain variation, the width of the particle-induced peak in the frequency distribution graph is often larger than the width of the liquid-induced peak. As described above, the present inventors have found that the ratio of the frequency derived from the particle-induced peak to the total frequency of the frequency distribution graph shows a good correlation with the number density of the particle in the liquid.

### (IN-Liquid Element Concentration Quantification Step (Step S7))

In this method, when the liquid contains a second element, the second element in the liquid can be quantified from the frequency distribution graph. FIG. 9 is an example of a graph showing a calibration curve in the embodiment, and a graph showing a calibration curve whose horizontal axis is the Al concentration in the liquid (Al-containing molten zinc alloy) and whose vertical axis is the normalized intensity (the emission intensity of the second element/the emission intensity of the first element) at the peak top position (the central position of the liquid-induced peak in the horizontal axis in FIG. 7) attributed to the liquid in the frequency distribution graph. In FIG. 9, the vertical axis represents normalized intensity, and the unit of the vertical axis is dimensionless.

When Al is quantified in the Al-containing molten zinc alloy, for example, as shown in FIG. 9, a correlation (calibration curve) between the normalized intensity at the peak top position of the liquid-induced peak and Al in the liquid (Al-containing molten zinc alloy) is prepared in advance. Then, when the liquid to be measured (Al-containing molten zinc alloy) can be subjected to LIBS to measure the normalized intensity at the peak top position of the liquid-induced peak, the Al concentration in the liquid (Al-containing molten zinc alloy) can be quantified using the calibration curve created in advance. Therefore, by using not only the correlation between the number of particles and the ratio of a frequency derived from the particle-induced peak to the total frequency of the frequency distribution graph but also the correlation between the concentration of the second element in the liquid and the normalized intensity at the peak top position of the liquid-induced peak in the frequency distribution graph, it is possible to quantify not only the abundance of the particle in the liquid containing a particle as the sample to be measured but also the concentration of the second element in the liquid. Therefore, the analysis method of a liquid containing a particle according to the embodiment preferably includes the in-liquid element concentration quantification step, in which the concentration of the second element in the liquid is quantified based on the correlation between the concentration of the second element in the liquid and the normalized intensity at the peak top position of the liquid-induced peak in the frequency distribution graph.

According to the analysis method of a liquid containing a particle of the embodiment, creating a calibration curve omits time and labor because the cutting and polishing of a sample and the observation thereof for each liquid for quantification of the particle are omitted. Therefore, the particle can be easily quantified.

### <Hot-Dip Galvanizing Device>

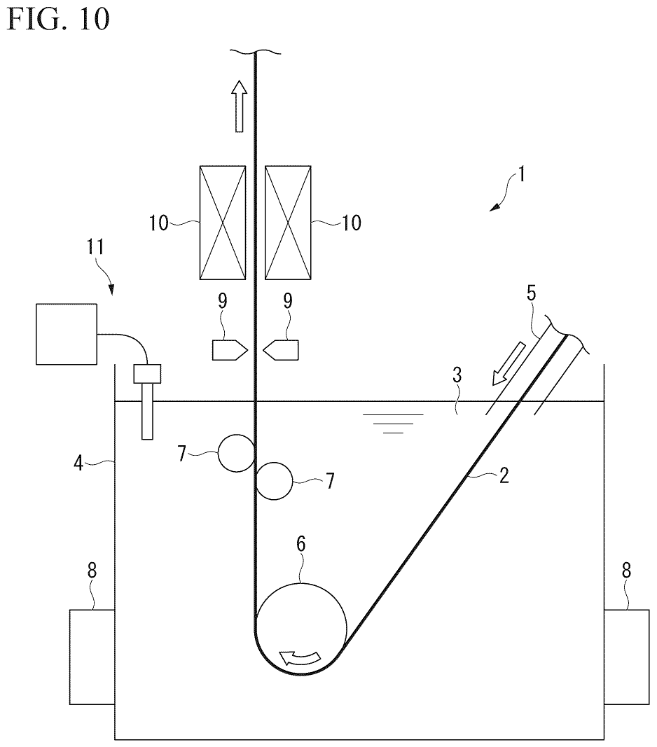

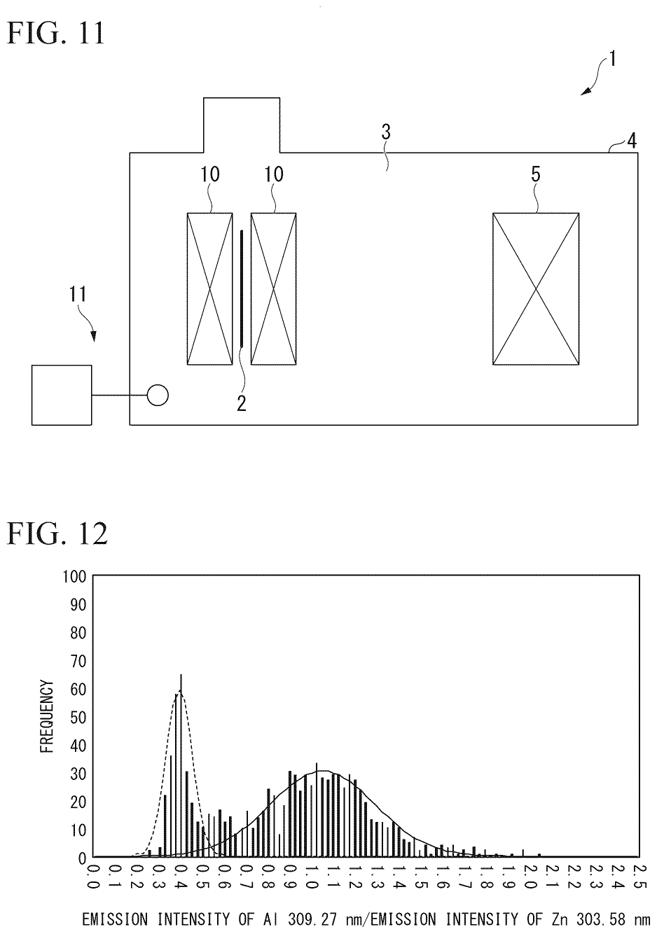

The analysis system for a particle in a liquid according to the embodiment can be applied to a hot-dip galvanizing device. Here, an example of the hot-dip galvanizing device will be described. FIG. 10 is a side view illustrating the schematic configuration of a hot-dip galvanizing device 1 to which the analysis method of a particle in a liquid according to the embodiment can be applied, and FIG. 11 is a plan view illustrating the schematic configuration of the hot-dip galvanizing device 1 illustrated in FIG. 10. Note that, as an example of a molten metal bath, a hot-dip galvanizing bath 3 (hereinafter, also simply referred to as “plating bath”) in the hot-dip galvanizing device 1 will be representatively described, but the present invention is naturally not limited thereto, and can be applied to any other molten metal bath.

The hot-dip galvanizing device 1 is a device for continuously attaching molten zinc to the surface of a steel strip 2 by immersing the steel strip 2 in the plating bath 3 filled with molten zinc. The hot-dip galvanizing device 1 includes a plating tank 4, a snout 5, a pair of upper and lower support rolls 7 and 7, an inductor 8, a gas wiping device 9, an alloying furnace 10, and a component analysis system 11.

The plating tank 4 stores the plating bath 3 made of molten zinc. Note that, the plating bath 3 may contain, for example, about 0.12 to 0.15 mass % of Al and about 0.02 to 0.1 mass % of Fe in addition to Zn. The temperature of the plating bath 3 is about 440 to 480 °C. The snout 5 is inclined such that one end thereof is immersed in the plating bath 3. An in-bath roll 6 is disposed at a lowermost position inside the plating tank 4. The in-bath roll 6 rotates along the illustrated arrow by contact and shearing with the steel strip 2.

The support rolls 7 are disposed on a downstream side of the in-bath roll 6 in a conveyance direction of the steel strip 2 inside the plating tank 4, and are disposed so as to sandwich the steel strip 2 fed from the in-bath roll 6 between the left support roll 7 and the right support roll 7. The support rolls 7 are rotatably supported by a bearing (not illustrated) (for example, a sliding bearing or a rolling bearing). Note that only one support roll or three or more support rolls may be disposed, or no support roll may be disposed.

The inductor 8 is an example of a heating device that heats the plating bath 3 filled in the plating tank 4. As illustrated in FIG. 10, a plurality of the inductors 8 are disposed on side wall portions of the plating tank 4 to adjust the plating bath 3 to a predetermined bath temperature. Note that the means for heating the plating bath 3 is not limited to the inductor 8, and a known technique is used.

The gas wiping device 9 is disposed above the plating tank 4, and has a function of spraying a gas (for example, nitrogen or air) onto both surfaces of the steel strip 2 to scrape off molten metal adhering to the surfaces of the steel strip 2, thereby controlling the adhesion amount of the molten metal.

The alloying furnace 10 is an example of a heating device that heats the steel strip 2 after gas wiping to a predetermined temperature. The alloying furnace 10 increases the temperature of the steel strip 2 by heating to promote alloying of the plating layer of the molten metal adhering to the surface of the steel strip 2. Note that, as the alloying furnace 10, for example, a known technique such as an induction heating type heater is used.

The steel strip 2 annealed in an annealing furnace, which is an upstream step, is immersed in the plating tank 4 filled with the plating bath 3 via the snout 5, passes the in-bath roll 6 and the support rolls 7 and 7, is pulled up in the vertical direction, and is conveyed to the outside of the plating bath 3. The basis weight of the molten metal adhering to the surface of the steel strip 2 conveyed to the outside of the plating bath 3 is adjusted by the gas wiping device 9, and then the steel strip 2 passes the alloying furnace 10.

As illustrated in FIG. 3, the component analysis system 11 is disposed in the vicinity of the corner portion of the plating bath 3, but is not limited to the illustrated embodiment, and can be disposed at any place of the plating bath 3, and can be used to measure any position of the plating bath 3. The component analysis system 11 is as described above.

As described above, the analysis method of a liquid containing a particle according to an embodiment of the present invention can be applied to a hot-dip galvanizing device, and is suitable for managing a hot-dip galvanizing bath. Therefore, in another aspect, the embodiment also relates to a managing method of a hot-dip galvanizing bath in which a hot-dip galvanizing bath containing a particle is irradiated with a laser and emission generated every time the laser is emitted is subjected to spectroscopic analysis to analyze the hot-dip galvanizing bath and manage the hot-dip galvanizing bath, the managing method including: a laser focusing step of focusing the laser beam; an emission intensity measurement step of obtaining: an emission intensity of a first element selected from elements contained in the liquid; and an emission intensity of a second element selected from elements each of which is contained in the liquid and in the particle, and has a concentration in the liquid and a concentration in the particle, the concentrations being different from each other; a normalization step of normalizing the emission intensity of the second element with the emission intensity of the first element to obtain a normalized intensity of the second element; a frequency distribution graph creating step of creating a frequency distribution graph showing a frequency distribution of the normalized intensity; a particle-induced peak identification step of identifying: a liquid-induced peak attributed to the liquid; and a particle-induced peak attributed to the particle in the frequency distribution graph; and a particle quantification step of determining the total frequency derived from the particle-induced peak and quantifying an abundance of the particle based on the ratio of a frequency derived from the particle-induced peak to the total frequency of the frequency distribution graph.

For managing a hot-dip galvanizing bath, as necessary, after liquids containing a particle and having an abundance of the particle different from each other are prepared in advance to perform the calibration curve creating step to create a calibration curve, the abundance of the particle may be quantified by using the calibration curve in the particle quantification step. For managing a hot-dip galvanizing bath, as necessary, in the peak identification step, an approximate curve in the frequency distribution graph is calculated to identify: the liquid-induced peak; and the particle-induced peak, and in the particle quantification step, a frequency derived from the particle-induced peak is quantified from the calculated approximate curve.

Furthermore, a hot-dip galvanized steel sheet can be suitably manufactured using the hot-dip galvanizing bath thus managed. Therefore, in another aspect, the present invention also relates to a manufacturing method of a hot-dip galvanized steel sheet, the manufacturing method including: a step of managing a hot-dip galvanizing bath by the managing method of a hot-dip galvanizing bath.

The present invention has been described above on the basis of the preferred embodiments of the present invention, but the present invention is not limited thereto. The above embodiments are merely examples, and anything having substantially the identical configuration as the technical idea described in the claims of the present invention and exhibiting similar operation and effects is included in the technical scope of the present invention.

For example, in the laser focusing step, the focused size is preferably adjusted to be smaller than 10 times the average particle size of the particle. To adjust the focused size as described above, an average particle size measurement step of measuring an average particle size of the particle present in the liquid may be included before the laser focusing step. When the particle size distribution of the particles present in the liquid is measured and the average particle size of the particle is measured, the laser focusing conditions can be easily controlled. The average particle size can be measured by a known method. Examples of a method for measuring fine particles in a liquid include particle measurement techniques such as a light scattering method, a light diffraction method, a microscopy method such as an electron microscope and an X-ray microscope, an electrostatic method, a sedimentation method, an inertial method, and a diffusion method. In the case of a liquid metal, a part of the liquid metal is collected, quenched and solidified, cut and polished, and observed with a microscope, whereby the size of the contained fine particles can be known. When the lower limit of the average particle size of the particles present in the liquid is clear, the average particle size measurement step is not necessary, and the focused size may be 10 times or less the lower limit of the average particle size.

For example, preferably, the liquid itself is flowing, or there is a mechanism to flow the liquid, in order that the laser is not emitted to the same portion of the liquid several times but emitted to a new surface of the liquid. As the mechanism to flow the liquid, heat convection may be used, or when the liquid is molten metal, the liquid may be forcibly stirred by a metal pump or the like. In addition, it is effective to use a method in which a probe to transmit the laser or the emission is immersed into the liquid and then an inert gas is properly blown to stir the liquid inserted into the probe and newly obtain an analysis surface of the liquid. By this method, the laser-irradiated portion is always a new liquid surface, so that the representativeness of analysis can be ensured.

In addition, in the analysis method for a liquid described above, a liquid containing one kind of particle, specifically, an Al-containing molten zinc alloy containing dross has been described as an example. However, even in a case where the liquid contains a plurality of particles having compositions different from each other, the analysis method for a liquid described above can be applied. For example, when the liquid contains a plurality of kinds of particles having different compositions from each other, a histogram showing a peak of the liquid and a plurality of peaks indicating peaks of particles having different compositions is obtained.

The analysis method of a liquid containing a particle described above is not limited to molten metal, and can be widely applied to suspended particles in a liquid. For example, carbon dioxide dissolved in water and suspended organic substances such as microorganisms and microplastics may be fractionated and quantified focusing on carbon, which is a commonly contained element. In addition, a solid suspension formed together with the deterioration of oil such as oxidation or saponification in a liquid oil may be separately analyzed.

### EXAMPLES

Hereinafter, the present invention will be described in more detail with reference to Examples. Note that Examples described below are merely examples of the present invention, and do not limit the present invention.

### Example 1

Using a laser emission spectrophotometer, a plating bath used for Sendzimir type continuous hot-dip galvanization was analyzed. A small amount of Al was added to the molten zinc, which was a plating bath, and a small amount of Fe was dissolved in the bath because iron plates are passed therethrough. As a result, alloy (Fe₂Al₅Znₓ) particles called top dross were suspended near the surface of the plating bath in a state where the average particle size was 10 to 20 μm and the particle size distribution width was several μm to about 100 μm. In addition, the dross amount in the plating bath was changed by adjusting components, temperature, holding time, and the like.

A laser was oscillated using Quantel Ultra100 manufactured by Lumibird. As the laser oscillation conditions, the wavelength was 1064 nm, the output was 100 mJ/pulse, and the frequency was 20 Hz. The oscillated laser passed through a cylindrical probe made of sialon having a length of 1000 mm and was focused by a lens provided with an antireflection coating so as to be focused on the surface of the plating bath. The focal length f of the lens was 900 mm, and the focused size of the laser was 50 μm.

Emission generated on the surface of the plating bath by laser irradiation was passed through the cylindrical probe, deviated by 90° from the optical axis of the laser with a dichroic mirror, focused with a lens, and then transmitted to a spectrometer through a 15 m length and 32 core optical fiber (Type I standard fiber manufactured by MITSUBISHI CABLE INDUSTRIES, LTD.). As the spectrometer, a double grating spectrometer (NP250-2) manufactured by SOL instrument was used. As a detector, ICCD Camera iStar manufactured by Andor was used.

For the spectrum obtained for each laser irradiation pulse, the emission intensity of Al (second element) at a wavelength of 309.27 nm was divided by the emission intensity of Zn (first element) at a wavelength of 303.58 nm, and this value was expressed as Al/Zn. Then, 1000 spectra were collected to create a frequency distribution graph whose horizontal axis was Al/Zn and whose vertical axis was the appearance frequency thereof. In the frequency distribution graph, the number of data was 1000, and the number of bins was 25. Next, approximation based on the Levenberg-Marquardt algorithm was performed, and two peaks, that is, the liquid-induced peak and the particle-induced peak, were successfully separated in the frequency distribution graph.

For each molten zinc alloy having the Al concentration and the number of dross shown in Levels 1 to 4 in Table 1, the liquid-induced peak and the particle-induced peak (dross peak) in the frequency distribution graph were identified by the method described above. Since the amount of Al in the particle (dross) was larger than the amount of Al in the liquid, which is relatively larger than Al/Zn of the molten metal, it was determined that the peak located on the high Al/Zn side was the peak attributed to the dross. In addition, the Al concentration and the abundance of dross in the molten zinc alloy were measured by a conventional method. Specifically, about 300 g of the molten metal at Levels 1 to 4 was collected with a dipper. The collected analysis sample was rapidly cooled and solidified with a water cooling mold made of copper. This analysis sample was removed from the mold, cut into two, and one of them was cut with a drill, one gram of the cut powder was weighed, completely decomposed with nitric acid and hydrochloric acid, and then subjected to an ICP emission spectroscopic analyzer to quantitatively analyze the Al concentration. For the remaining piece, a smooth surface was obtained with a milling device, and then a cross section was prepared using a mirror polishing device. The cross section was subjected to a Nital etching treatment, and then observed with an optical microscope to measure the number of dross having a particle area of 10 μm or more (piece/cm²). The cross section observation was performed on 20 new cross sections by repeating milling and mirror polishing on an area of about 2 cm×2 cm. That is, about 80 cm² was observed. This observation was performed on the analysis sample collected under the conditions of Levels 1 to 4. The average diameter of the dross at Levels 1 to 4 was less than 5 μm.

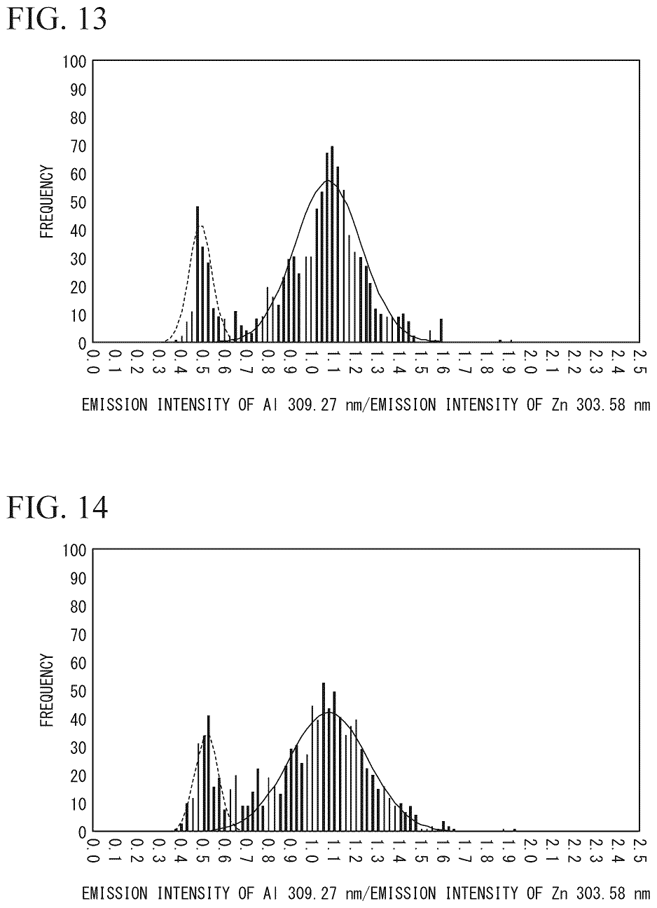

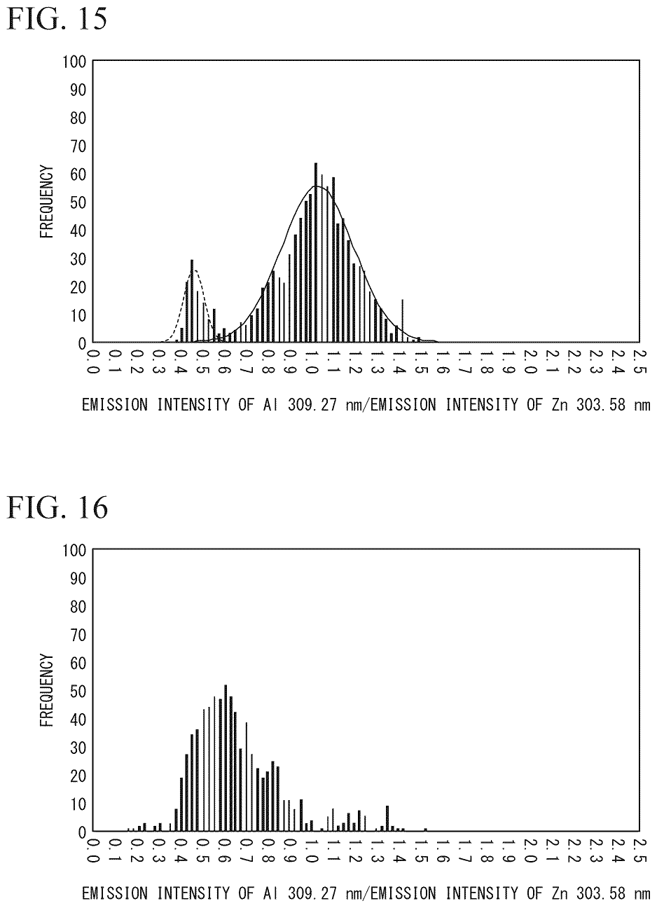

The upper part of the reference value column in Table 1 shows the Al concentration in molten zinc by ICP emission spectroscopy (Al concentration in Table 1), and the lower part of the reference value column shows the number of dross by cross section observation. The upper part of the example column in Table 1 shows the normalized intensity at the peak top position of molten zinc in the frequency distribution graph, and the lower part of the example column shows the ratio of the frequency derived from the particle (dross)-induced peak to the total frequency of the frequency distribution graph. FIG. 12 shows a frequency distribution graph in which peak separation has been performed for Level 1; FIG. 13 shows a frequency distribution graph in which peak separation has been performed for Level 2; FIG. 14 shows a frequency distribution graph in which peak separation has been performed for Level 3; and FIG. 15 shows a frequency distribution graph in which peak separation has been performed for Level 4. Here, as shown in FIGS. 12 to 15, the liquid-induced peak and the particle-induced peak overlapped each other for Levels 1 to 4. Therefore, an approximate curve was fitted based on the Levenberg-Marquardt algorithm as described above. Then, the “the area of the approximate curve derived from the particle-induced peak”/(“the area of the approximate curve derived from the liquid-induced peak”+“the area of the approximate curve derived from the particle-induced peak”) is regarded as the ratio of the frequency derived from the particle-induced peak to the total frequency of the frequency distribution graph.

TABLE 1

| | | Level | Level | Level | Level |
|---|---|---|---|---|---|
| | | 1 | 2 | 3 | 4 |
| Exam- | Normalized intensity | 0.400 | 0.500 | 0.525 | 0.475 |
| ple | at peak top position of | | | | |
| | molten zinc in frequency | | | | |
| | distribution graph | | | | |
| | Ratio of frequency | 0.72 | 0.91 | 0.84 | 0.88 |
| | derived from particle- | | | | |
| | induced peak to total | | | | |
| | frequency of frequency | | | | |
| | distribution graph | | | | |
| Refer- | Al concentration (mass | 0.121 | 0.128 | 0.131 | 0.127 |
| ence | %) | | | | |
| value | Number of dross (piece/ | 96 | 152 | 123 | 140 |
| | cm²) | | | | |

Here, for Levels 1 to 4, FIG. 8 shows the relationship between the number of dross having a particle area of 10 μm or more (piece/cm²) observed using an optical microscope and the ratio of the frequency derived from the particle-induced peak to the total frequency of the frequency distribution graph. As shown in FIG. 8, the number of dross is proportional to the ratio of the frequency derived from the particle-induced peak to the total frequency of the frequency distribution graph. Therefore, it has been found that dross can be quantitatively analyzed by using the calibration curve shown in FIG. 8.

For the Sendzimir type continuous hot-dip galvanizing bath, LIBS was performed as described above in the same laser optical system (that is, the same focusing conditions) and in other several timings to measure the ratio of the frequency derived from the particle (dross)-induced peak to the total frequency of the frequency distribution graph, and the number of dross by LIBS was determined using the calibration curve in FIG. 8. At the same time, an analysis sample was collected in the same manner as described above, and the number of dross was measured by cross section observation. The ratio of the number of dross by LIBS and the number of dross by cross section observation was within 1.00±0.10, and the number of dross by LIBS well matched the number of dross by cross section observation.

In addition, FIG. 9 shows the relationship between the Al concentration in the liquid of Levels 1 to 4 (Al-containing molten zinc alloy) and the normalized intensity at the peak top position of the liquid-induced peak. As shown in FIG. 9, the Al concentration in the liquid (Al-containing molten zinc alloy) is proportional to the normalized intensity at the peak top position of the liquid-induced peak. Therefore, it has been found that the Al concentration in molten zinc can be quantitatively analyzed by using the calibration curve shown in FIG. 9.

On the other hand, for Levels 1 to 4, in the measurement of Al concentration in molten zinc by ICP emission spectrometry and the measurement of the number of dross by cross section observation, which are conventional measurement methods, it has been necessary that one operator engages for about 10 days. Therefore, when molten zinc containing dross to be measured is measured for the number of dross or the Al concentration, the method of the present invention is capable of measurement by LIBS using a calibration curve. Therefore, it has been found to easily measure them in a short time as compared with conventional methods.

### Example 2

Analysis was performed under the conditions of Level 1 except that the focal lens was changed and the focused size was 500 μm. Then signal processing similar to that in the invention example was performed to create a histogram. The results are shown in FIG. 15. Although some spectra with high Al/Zn ratio, which is probably attributed to dross, were detected, the histogram was broad. This is presumably because the laser focused size is much larger than the dross, the emission from the molten metal becomes dominant even under the presence of dross immediately below the laser, and the spectrum is averaged. Therefore, it has been found that molten zinc and dross can be distinguished with higher accuracy by setting the focused size within an appropriate range.

Although the preferred embodiments of the present invention have been described in detail with reference to the accompanying drawings, the present invention is not limited to such examples. It is obvious that a person having ordinary knowledge in the technical field to which the present invention belongs can conceive various changes or modifications within the scope of the technical idea described in the claims, and it is naturally understood that these also belong to the technical scope of the present invention.

### REFERENCE SIGNS LIST

1 Hot-dip galvanizing device
2 Steel strip
3 Plating bath (Molten metal)
4 Plating tank
5 Snout
6 In-bath roll
7 Support roll
8 Inductor
9 Gas wiping device
10 Alloying furnace
11 Component analysis system
12 Laser device
13 Cylindrical probe
131 Opening end
14 Transmission cable
15 Bubble
16 Plasma
17 Support member
18 Fixing member
19 Drive unit
20 Processing device
21 Detection unit
22 Signal processing unit
221 Laser focusing unit
222 Emission intensity measurement unit
223 Normalization unit
224 Frequency distribution graph creating unit
225 Peak identification unit
226 Particle quantification unit

1. An analysis method of a liquid containing a particle in which a liquid containing a particle is irradiated with a laser and emission generated every time the laser is emitted is subjected to spectroscopic analysis to analyze the liquid containing a particle, the analysis method comprising:
a laser focusing step of focusing the laser beam;
an emission intensity measurement step of obtaining: an emission intensity of a first element selected from elements contained in the liquid; and an emission intensity of a second element selected from elements each of which is contained in the liquid and in the particle, and has a concentration in the liquid and a concentration in the particle, the concentrations being different from each other;
a normalization step of normalizing the emission intensity of the second element with the emission intensity of the first element to obtain a normalized intensity of the second element;
a frequency distribution graph creating step of creating a frequency distribution graph showing a frequency distribution of the normalized intensity;
a peak identification step of identifying: a liquid-induced peak attributed to the liquid; and a particle-induced peak attributed to the particle in the frequency distribution graph; and
a particle quantification step of determining the total frequency derived from the particle-induced peak and quantifying an abundance of the particle based on the ratio of a frequency derived from the particle-induced peak to the total frequency of the frequency distribution graph.

2. The analysis method of a liquid containing a particle according to claim 1, comprising: a calibration curve creating step of creating a calibration curve showing a relationship between: a ratio of a total frequency derived from the particle-induced peak to a total frequency of the frequency distribution graph; and an abundance of the particle by:
preparing in advance liquids containing a particle and having an abundance of the particle different from each other;
analyzing a sample collected from the liquid to measure an abundance of the particle in the liquid; and
subjecting the liquid to the analysis method of claim 1 upon collecting the sample from the liquid to determine a ratio of a total frequency derived from the particle-induced peak to a total frequency of the frequency distribution graph,
wherein, in the particle quantification step, the calibration curve is used to quantify an abundance of the particle.

3. The analysis method of a liquid containing a particle according to claim 1, wherein,
in the peak identification step, an approximate curve in the frequency distribution graph is calculated to identify: the liquid-induced peak; and the particle-induced peak, and
in the particle quantification step, a frequency derived from the particle-induced peak is quantified from the calculated approximate curve.

4. The analysis method of a liquid containing a particle according to claim 1, comprising, before the laser focusing step,
an average particle size measurement step of measuring an average particle size of the particle present in the liquid.

5. The analysis method of a liquid containing a particle according to claim 1, wherein, in the laser focusing step, the laser is set to have a focused spot with a diameter smaller than 10 times an average particle size of the particle.

6. The analysis method of a liquid containing a particle according to claim 1, wherein, in the laser focusing step, the emission intensity measurement step is performed while changing a diameter of a focused spot of the laser, and the normalization step, the frequency distribution graph creating step, and the peak identification step are performed for each diameter of a focused spot, to determine a focusing condition of the laser.

7. The analysis method of a liquid containing a particle according to claim 1, wherein the liquid is a molten metal.

8. The analysis method of a liquid containing a particle according to claim 1, wherein the liquid is a molten zinc alloy in which molten zinc contains at least aluminum.

9. The analysis method of a liquid containing a particle according to claim 1, wherein, in the laser focusing step, the laser is set to have a focused spot with a diameter of less than 300 μm.

10. The analysis method of a liquid containing a particle according to claim 1, wherein, in the laser focusing step, the laser is controlled to have a focused spot with a diameter of 5 μm or more and less than 100 μm.

11. A managing method of a hot-dip galvanizing bath in which a hot-dip galvanizing bath containing a particle is irradiated with a laser and emission generated every time the laser is emitted is subjected to spectroscopic analysis to analyze the hot-dip galvanizing bath and manage the hot-dip galvanizing bath, the managing method comprising:
a laser focusing step of focusing the laser beam;
an emission intensity measurement step of obtaining: an emission intensity of a first element selected from elements contained in the hot-dip galvanizing bath; and an emission intensity of a second element selected from elements each of which is contained in the liquid and in the particle, and has a concentration in the liquid and a concentration in the particle, the concentrations being different from each other;
a normalization step of normalizing the emission intensity of the second element with the emission intensity of the first element to obtain a normalized intensity of the second element;
a frequency distribution graph creating step of creating a frequency distribution graph showing a frequency distribution of the normalized intensity;
a peak identification step of identifying: a liquid-induced peak attributed to the liquid; and a particle-induced peak attributed to the particle in the frequency distribution graph; and
a particle quantification step of determining the total frequency derived from the particle-induced peak and quantifying an abundance of the particle based on the ratio of a frequency derived from the particle-induced peak to the total frequency of the frequency distribution graph.

12. A manufacturing method of a hot-dip galvanized steel sheet, the manufacturing method comprising: a step of managing a hot-dip galvanizing bath by the managing method of a hot-dip galvanizing bath according to claim 11.

13. An analyzer for a liquid containing a particle with which a liquid containing a particle is irradiated with a laser and emission generated every time the laser is emitted is subjected to spectroscopic analysis to analyze the liquid containing a particle, the analyzer comprising:
a laser focusing unit to concentrate the laser beam;
an emission intensity measurement unit to obtain: an emission intensity of a first element selected from elements contained in the liquid; and an emission intensity of a second element selected from elements each of which is contained in the liquid and in the particle, and has a concentration in the liquid and a concentration in the particle, the concentrations being different from each other;
a normalization unit to normalize the emission intensity of the second element with the emission intensity of the first element to obtain a normalized intensity of the second element;
a frequency distribution graph creating unit to create a frequency distribution graph showing a frequency distribution of the normalized intensity;
a peak identification unit to identify: a liquid-induced peak attributed to the liquid; and a particle-induced peak attributed to the particle in the frequency distribution graph; and
a particle quantification unit to determine a total frequency derived from the particle-induced peak and to quantify an abundance of the particle based on a ratio of a frequency derived from the particle-induced peak to a total frequency of the frequency distribution graph.
